(19) United States
(12) Patent Application Publication
(10) Pub. No.: US 2019/0066632 A1
(43) Pub. Date: Feb. 28, 2019

(54) METHOD AND SYSTEM FOR PROTECTING SOFTWARE DATA IN DISPLAY PANEL

(71) Applicants: HKC Corporation Limited, Shenzhen City, Guangdong (CN); Chongqing HKC Optoelectronics Technology Co., Ltd., Chongqing (CN)

(72) Inventor: Mingliang WANG, Chongqing (CN)

(21) Appl. No.: 15/580,627

(22) PCT Filed: Sep. 19, 2017
(86) PCT No.: PCT/CN2017/102198

§ 371 Date: Dec. 7, 2017

(30) Foreign Application Priority Data
Aug. 28, 2017 (CN) 201710752531.X

(51) Int. Cl. G09G 5/393; G09G 3/36

(52) U.S. Cl. CPC G09G 5/393; G09G 3/3611; G09G 2330/04; G09G 2330/12; G09G 2310/08

(57) ABSTRACT

This application provides a method and system for protecting software data in a display panel. The method includes the following steps: providing a display panel and a storage unit, where the storage unit is disposed on a drive board of the display panel and is configured to store a write protection information and a software data of a TCON; detecting, by an information detection unit in the TCON, a state of the write protection information; and when the state of the write protection information is a write protection invalid state, rejecting, by an MCU in the TCON, and reading the software data of the TCON.

### BACKGROUND

### Technical Field

This application relates to the field of display technologies, and specifically, to a method and system for protecting software data in a display panel.

### Related Art

A liquid crystal display is one of the most widely used flat-panel displays and includes two base boards having a pixel electrode, a common electrode, and the like, and a liquid crystal layer inserted between the two base boards. The liquid crystal display determines, by using an electric field generated by a voltage applied to the electrode, orientation of liquid crystal molecules at the liquid crystal layer and controls polarization of incident light to display an image. The liquid crystal display is beneficial to displaying a motion image and has high contrast, thereby replacing an existing cathode-ray tube and being differently used as a display device (such as a notebook computer monitor), a computer monitor, a television, and the like of a mobile terminal.

There is a programmable erasable storage IC (EEPROM) on a drive board of a liquid crystal display panel. During a guiding process of a system, the programmable erasable storage IC reads model information (for example, resolution and timing) from the system to send the model information to a liquid crystal drive circuit unit. The EEPROM is a read and write memory and is used to store a software code setting of a timing control chip (TCON). However, during actual manufacturing of a factory, a case in which TCON code stored in the EEPROM is rewritten often easily occurs. When a machine is just switched on, a micro-processing unit (MCU) in the TCON reads, by means of an I2C protocol, the TCON code stored in the EEPROM to complete an initialization setting of the TCON. WP is a write protection signal of the EEPROM, and is H in a normal state. That is, the EEPROM is always in a write protection state in a normal state. However, at present, an easily occurring problem is that during manufacturing, the WP may be invalid due to wire or other interference, and I2C protocol communication is not normal. Consequently, a misoperation may occur, causing rewrite of the TCON code stored in the EEPROM. Nowadays, there is no correcting mechanism and this situation cannot be prevented, therefore causing an abnormal display picture and many errors.

### SUMMARY

In view of the foregoing disadvantages in the related art, this application provides a method and system for protecting software data in a display panel, so as to add detection of a TCON on a write protection signal. When detecting that the write protection signal is invalid, the TCON does not read TCON code. Therefore, rewrite of software data in a storage unit can be avoided, and a case in which a picture displayed by the display panel is abnormal is further avoided.

The objective of this application is achieved and the technical problem of this application is resolved by using the following technical solutions.

A method for protecting software data in a display panel provided in this application includes the following steps: providing a display panel and a storage unit, where the storage unit is disposed on a drive board of the display panel and is configured to store a write protection information and a software data of a TCON; detecting, by an information detection unit in the TCON, a state of the write protection information; and when the state of the write protection information is a write protection invalid state, rejecting, by an MCU in the TCON, and reading the software data of the TCON.

The method further includes: when the state of the write protection information detected by the information detection unit is a write protection state, reading, by the MCU, the software data of the TCON by using a serial communication unit (such as an I2C bus), to output various control signals used for driving the display panel.

The method further includes: when the state of the write protection information detected by the information detection unit is a write protection state, prohibiting, by the MCU, rewriting the software data on the storage unit.

The method further includes: when the state of the write protection information detected by the information detection unit is a write protection invalid state, prohibiting, by the MCU, rewriting the software data on the storage unit.

The method further includes: when the state of the write protection information detected by the information detection unit is a write protection release state, allowing, by the MCU, rewriting the software data on the storage unit.

The objective of this application is achieved and the technical problem of this application is further resolved by taking the following technical measures.

A system for protecting software data in a display panel provided in this application includes: a display panel; a storage unit, disposed on a drive board of the display panel and configured to store a write protection information and a software data of a TCON; and the TCON, disposed in the display panel, including: an information detection unit, configured to detect a state of the write protection information; and an MCU, configured to: when the state of the write protection information is a write protection invalid state, reject reading the software data of the TCON.

The MCU is further configured to: when the state of the write protection information detected by the information detection unit is a write protection state, read the software data of the TCON by using a serial communication unit (such as an I2C bus), to output various control signals used for driving the display panel.

The MCU is further configured to: when the state of the write protection information detected by the information detection unit is a write protection state or a write protection invalid state, prohibit rewriting the software data on the storage unit.

The MCU is further configured to: when the state of the write protection information detected by the information detection unit is a write protection release state, allow rewriting the software data on the storage unit.

A method for protecting software data in a display panel provided for another objective in this application includes: providing a display panel and a storage unit, where the storage unit is disposed on a drive board of the display panel and is configured to store a write protection information and a software data of a TCON; detecting, by an information detection unit in the TCON, a state of the write protection information; and when the state of the write protection information is a write protection invalid state, rejecting, by an MCU in the TCON, and reading the software data of the TCON, where the storage unit is connected to the TCON by using a serial communication bus (such as an I2C bus); and the storage unit is an EEPROM.

By means of the foregoing technical solutions and measures, this application provides a display panel and a storage unit. The storage unit is disposed on a drive board of the display panel and is configured to store a write protection information and a software data of a TCON; the TCON detects a state of the write protection information; when the state of the write protection information is a write protection invalid state, an MCU in the TCON rejects reading software data code of the TCON. The TCON serves as a source of an I2C signal. If the TCON does not output an I2C signal, the I2C signal is not substantively affected even if there is wire or other interference at a backend. In this case, a case in which the software data in the storage unit (EEPROM) is rewritten does not occur. When a machine is switched on again, provided that a signal calibration position of write protection WP restores to normal, the TCON still correctly reads the software data code in the storage unit, thereby correctly displaying a picture.

### BRIEF DESCRIPTION OF THE DRAWINGS

FIG. 1 is a schematic diagram of an exemplary communication architecture of a TCON and a storage unit in a display panel;

FIG. 2 is a schematic architectural diagram of a system for protecting software data in a display panel according to this application; and

FIG. 3 is a schematic flowchart of a method for protecting software data in a display panel according to this application.

### DETAILED DESCRIPTION

To further describe technical means used in a method and system for protecting software data in a display panel in this application to achieve a predetermined objective and an achieved effect, the following further describes specific implementations, structures, features, and effects of the method and system for protecting software data in a display panel in this application in detail with reference to the accompanying drawings and preferred embodiments.

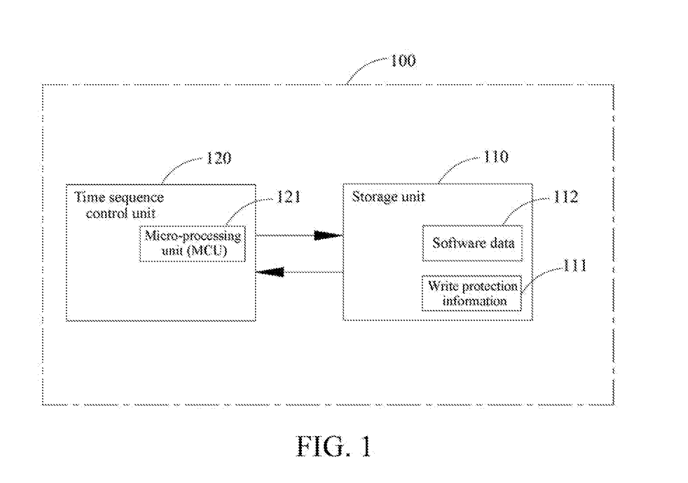

Referring to FIG. 1, FIG. 1 is a schematic diagram of an exemplary communication architecture of a TCON and a storage unit in a display panel.

In FIG. 1, FIG. 1 shows: a display panel 100; a storage unit 110, disposed on a drive board of the display panel 100 and configured to store a write protection information 111 and a software data 112 of a TCON 120; and the TCON 120, disposed in the display panel 100 and including an MCU 121. When a machine is switched on, the MCU 121 in the TCON 120 reads, by using a serial communication unit (such as an I2C bus), the software data 112 of the TCON 120 stored in the storage unit 110, to complete an initialization setting of the TCON 120. WP is write protection information 111 of the storage unit 110 and is H in a normal state. That is, the write protection information 111 is always in a write protection state in a normal state. However, at present, an easily occurring problem is that during manufacturing, the WP may be invalid due to wire or other interference, and I2C protocol communication is not normal. Consequently, a misoperation may occur, causing rewrite of the software data 112 of the TCON 120 stored in the storage unit 110. When the MCU 121 in the TCON 120 reads the rewritten software data, a reading error may be caused and the initialization setting of the TCON 120 cannot be completed. In addition, various control signals used for driving the display panel cannot be correctly output, therefore causing an abnormal display picture and many errors. Nowadays, there is no correcting mechanism and this situation cannot be prevented.

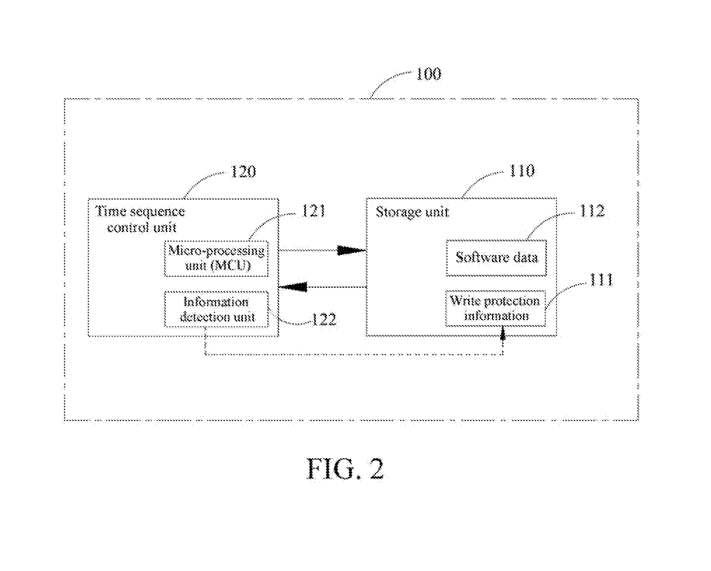

Referring to FIG. 2, FIG. 2 is a schematic architectural diagram of a system for protecting software data in a display panel according to this application.

In FIG. 2, the system for protecting software data in a display panel provided in this application includes: a display panel 100; a storage unit 110, disposed on a drive board of the display panel 100 and configured to store a write protection information 111 and a software data 112 of a TCON 120; and the TCON 120, disposed in the display panel 100 and including: an information detection unit 122, configured to detect a state of the write protection information 111; and an MCU 121, configured to: when the state of the write protection information 111 is a write protection invalid state, reject reading the software data 112 of the TCON 120.

In an embodiment, detection of the TCON 120 on the write protection information 111 is added. The write protection information 111 is the first barrier of determining whether the storage unit 110 is rewritten. If the write protection information 111 is started, that is, the storage unit 110 is always in a write protection state, regardless of any change of an I2C signal, the software data 112 in the storage unit 110 cannot be rewritten.

Specifically, for the storage unit 110, when the write protection information 111 is H, write protection is started; when the write protection information 111 is L, the write protection is invalid. When a machine is just switched on, the information detection unit 122 in the TCON 120 first detects the state of the write protection information 111. When the state of the write protection information 111 is detected to be a write protection invalid state, the MCU 121 in the TCON 120 does not read the software data 112 in the storage unit 110. The TCON 120 serves as a source of an I2C signal. If the TCON 120 does not output an I2C signal, the I2C signal is not substantively affected even if there is wire or other interference at a backend. In this case, a case in which the storage unit 110 is rewritten does not occur. When the machine is switched on again, provided that a signal calibration position of write protection information 111 restores to normal, the TCON 120 still correctly reads the software data 112, to output various control signals used for driving the display panel, thereby correctly displaying a picture.

In an embodiment, an EEPROM or the like is used as the storage unit 110. The EEPROM is a storage device storing data even if being closed and performs data sending and receiving with the TCON 120 by using a serial communication unit (for example, an I2C bus). I2C is a data communication method between a two-wire serial interface and an integrated circuit formed by a serial data line (SDA) and a serial clock line (SCL).

In an embodiment, when the state of the write protection information 111 detected by the information detection unit 122 is a write protection state, the software data 112 of the TCON 120 is read by using a serial communication unit (such as an I2C bus), to output various control signals used for driving the display panel 100.

In an embodiment, when the state of the write protection information 111 detected by the information detection unit 122 is a write protection state or a write protection invalid state, it is prohibited to rewrite the software data 112 on the storage unit 110.

In an embodiment, when the state of the write protection information 111 detected by the information detection unit 122 is a write protection release state, it is allowed to rewrite the software data 112 on the storage unit 110.

In an embodiment, the display panel 100 is specially described as follows by using a liquid crystal display panel as an example: the liquid crystal display panel has matrix-type pixel areas obtained by arranging a plurality of select lines and a plurality of data lines in a direction in which the plurality of select lines and the plurality of data lines are perpendicular to each other. Each of the pixel areas includes a thin film transistor (TFT) and a liquid crystal capacitor (Clc) connected to the TFT. The liquid crystal capacitor (Clc) is formed by a pixel electrode connected to the TFT and a common electrode inserted between the pixel electrode and liquid crystal. The TFT provides a data voltage from each data line to the pixel electrode in response to a scanning pulse from each select line. A difference voltage (differenceoltage) between the data voltage provided to the pixel electrode and a reference common voltage provided to the common electrode is charged to the liquid crystal capacitor (Clc). The liquid crystal capacitor (Clc) changes orientation of liquid crystal molecules according to the difference voltage, thereby controlling a light transmittance. In addition, a storage capacitor (Cst) and the liquid crystal capacitor (Clc) are connected in parallel to keep the voltage charged in the liquid crystal capacitor till a next data signal is provided.

The TCON reads the software data stored in the storage unit, to output an operation signal used for operating a DC-DC converter and various control signals used for operating the liquid crystal display panel. Herein, the TCON inputs an input/output control clock (CLK) to the storage unit to receive drive information of the liquid crystal display panel and image data modulation information, and controls a select driver and a data driver based on the drive information and the image data modulation information. The data driver receives a rectified video signal from the TCON to convert the rectified video signal to a rectified data signal (which is an analogue signal), and provides the rectified data signal to a corresponding data line of the liquid crystal display panel.

The storage unit stores the size of the liquid crystal display panel, resolution conversion information, the image data modulation information, the drive frequency, drive timing information of the TCON, and the like. In addition, when the input/output control clock is input, the storage unit provides the stored drive information, image data modulation information, and the like to the TCON.

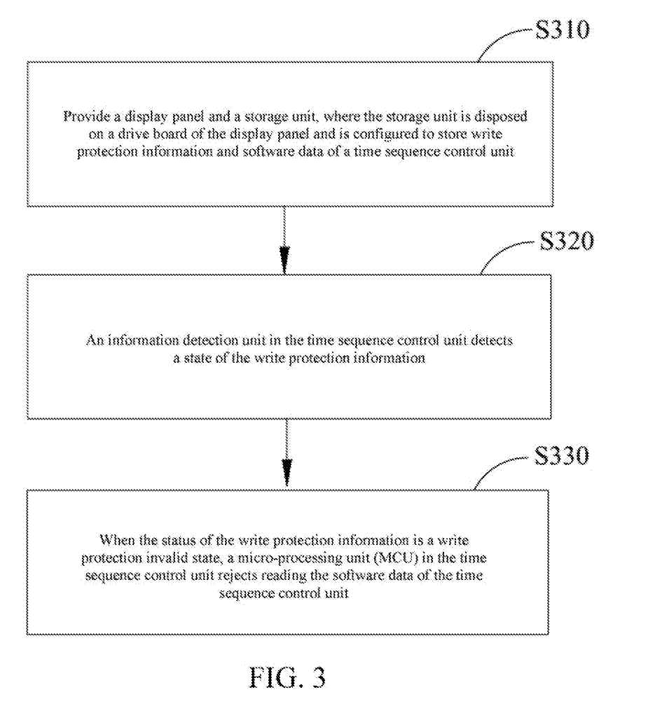

Referring to FIG. 3, FIG. 3 is a schematic flowchart of a method for protecting software data in a display panel according to this application. The method includes the following steps:

Step S310: Provide a display panel and a storage unit, where the storage unit is disposed on a drive board of the display panel and is configured to store a write protection information and a software data of a TCON.

Step S320: An information detection unit in the TCON detects a state of the write protection information.

Step S330: When the state of the write protection information is a write protection invalid state, an MCU in the TCON rejects reading the software data of the TCON.

In an embodiment, an EEPROM or the like is used as the storage unit. The EEPROM is a storage device storing data even if being closed and performs data sending and receiving with the TCON by using a serial communication unit (for example, an I2C bus). I2C is a data communication method between a two-wire serial interface and an integrated circuit formed by an SDA and an SCL.

In an embodiment, the method further includes: when the state of the write protection information detected by the information detection unit is a write protection state, reading, by the MCU, the software data of the TCON by using a serial communication unit (such as an I2C bus), to output various control signals used for driving the display panel.

In an embodiment, the method further includes: when the state of the write protection information detected by the information detection unit is a write protection state, prohibiting, by the MCU, rewriting the software data on the storage unit.

In an embodiment, the method further includes: when the state of the write protection information detected by the information detection unit is a write protection invalid state, prohibiting, by the MCU, rewriting the software data on the storage unit.

In an embodiment, the method further includes: when the state of the write protection information detected by the information detection unit is a write protection release state, allowing, by the MCU, rewriting the software data on the storage unit.

In an embodiment, the display panel may be a TN, an OCB, or a VA type TFT liquid crystal display panel. This is not limited herein. The display panel of a display device may be a liquid crystal display panel having a curved panel. The display panel may alternatively be an OLED display panel, a QLED display panel, a curved display panel, or another display panel.

This application provides a method and system for protecting software data in a display panel. A display panel and a storage unit are provided. The storage unit is disposed on a drive board of the display panel and is configured to store a write protection information and a software data of a TCON; an information detection unit in the TCON detects a state of the write protection information; when the state of the write protection information is a write protection invalid state, an MCU in the TCON rejects reading the software data of the TCON. The TCON serves as a source of an I2C signal. If the TCON does not output an I2C signal, the I2C signal is not substantively affected even if there is wire or other interference at a backend. In this case, a case in which the software data in the storage unit (EEPROM) is rewritten does not occur. When the machine is switched on again, provided that a signal calibration position of write protection information restores to normal, the TCON still correctly reads software data code of the TCON in the storage unit to complete an initialization setting of the TCON, so as to output various control signals used for driving the display panel. By means of reliable timing control signals, the display panel is controlled to stably display a picture.

The foregoing descriptions are merely preferred embodiments of this application, and are not intended to limit this application in any form. Although this application has been disclosed above through the preferred embodiments, the embodiments are not intended to limit this application. Any person skilled in the art can make some variations or modifications, which are equivalent changes, according to the foregoing disclosed technical content to obtain equivalent embodiments without departing from the scope of the technical solutions of this application. Any simple amendment, equivalent change, or modification made to the above embodiments according to the technical essence of this application without departing from the content of the technical solutions of this application shall fall within the scope of the technical solutions of this application.

What is claimed is:

1. A method for protecting software data in a display panel, comprising:
providing a display panel and a storage unit, wherein the storage unit is disposed on a drive board of the display panel and is configured to store a write protection information and a software data of a timing control unit (TCON);
detecting, by an information detection unit in the TCON, a state of the write protection information; and
when the state of the write protection information is a write protection invalid state, rejecting, by a micro-processing unit (MCU) in the TCON, and reading the software data of the TCON.

2. The method for protecting software data in a display panel according to claim 1, further comprising: when the state of the write protection information detected by the information detection unit is a write protection state, reading, by the MCU, the software data of the TCON by using a serial communication unit.

3. The method for protecting software data in a display panel according to claim 2, further comprising: outputting, by the MCU, various control signals used for driving the display panel.

4. The method for protecting software data in a display panel according to claim 1, further comprising: when the state of the write protection information detected by the information detection unit is a write protection state, prohibiting, by the MCU, rewriting the software data on the storage unit.

5. The method for protecting software data in a display panel according to claim 1, further comprising: when the state of the write protection information detected by the information detection unit is a write protection invalid state, prohibiting, by the MCU, rewriting the software data on the storage unit.

6. The method for protecting software data in a display panel according to claim 1, further comprising: when the state of the write protection information detected by the information detection unit is a write protection release state, allowing, by the MCU, rewriting the software data on the storage unit.

7. The method for protecting software data in a display panel according to claim 1, wherein the storage unit is connected to the TCON by using a serial communication unit.

8. The method for protecting software data in a display panel according to claim 1, wherein the storage unit is an erasable programmable read-only memory.

9. 1. A system for protecting software data in a display panel, comprising:
a display panel;
a storage unit, disposed on a drive board of the display panel and configured to store a write protection information and a software data of a TCON; and
the TCON, disposed in the display panel, comprising:
an information detection unit, configured to detect a state of the write protection information; and
an MCU, configured to: when the state of the write protection information is a write protection invalid state, reject reading the software data of the TCON.

10. The system for protecting software data in a display panel according to claim 9, wherein the MCU is further configured to: when the state of the write protection information detected by the information detection unit is a write protection state, read the software data of the TCON by using a serial communication unit.

11. The system for protecting software data in a display panel according to claim 10, wherein the MCU is further configured to output various control signals used for driving the display panel.

12. The system for protecting software data in a display panel according to claim 9, wherein the MCU is further configured to: when the state of the write protection information detected by the information detection unit is a write protection state, prohibit rewriting the software data on the storage unit.

13. The system for protecting software data in a display panel according to claim 9, wherein the MCU is further configured to: when the state of the write protection information detected by the information detection unit is a write protection invalid state, prohibit rewriting the software data on the storage unit.

14. The system for protecting software data in a display panel according to claim 9, wherein the MCU is further configured to: when the state of the write protection information detected by the information detection unit is a write protection release state, allow rewriting the software data on the storage unit.

15. The system for protecting software data in a display panel according to claim 9, wherein the storage unit is connected to the TCON by using a serial communication unit.

16. The system for protecting software data in a display panel according to claim 9, wherein the storage unit is an erasable programmable read-only memory.

17. A method for protecting software data in a display panel, comprising:
providing a display panel and a storage unit, wherein the storage unit is disposed on a drive board of the display panel and is configured to store a write protection information and a software data of a TCON;
detecting, by an information detection unit in the TCON, a state of the write protection information; and
when the state of the write protection information is a write protection invalid state, rejecting, by an MCU in the TCON, and reading the software data of the TCON, wherein
the storage unit is connected to the TCON by using a serial communication unit; and
the storage unit is an erasable programmable read-only memory.
